(19) United States
(12) Patent Application Publication
(10) Pub. No.: US 2010/0118651 A1
(43) Pub. Date: May 13, 2010

(54) METHOD FOR GENERATION OF IMAGES RELATED TO A SUBSURFACE REGION OF INTEREST

(75) Inventors: Wei Liu, San Ramon, CA (US); Tamas Nemeth, San Ramon, CA (US); Raymond Ergas, San Clemente, CA (US); Oliver Pell, London (GB)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/566,252

(22) Filed: Sep. 24, 2009

Related U.S. Application Data
(60) Provisional application No. 61/113,075, filed on Nov. 10, 2008.

(51) Int. Cl. G01V 1/28

(52) U.S. Cl. 367/50

(57) ABSTRACT

A method and system for generating images of a subsurface region of interest. In general, one embodiment of the present invention includes establishing boundary conditions utilizing seismic data and initial conditions which include excitation from source locations in an earth model. Source wavefields are then propagated forward through the earth model to a maximum time, and saved at a plurality of checkpoints sparsely in time and also corresponding boundary values of the source wavefields at each time step are saved. Source wavefields are also propagated backward through the earth model from the maximum time utilizing the plurality of checkpoints when available and the saved boundary values at each time step. Receiver wavefields are propagated backward concurrently through the earth model from the maximum time. Imaging conditions are applied at selected time steps to both the backward propagated source wavefields and receiver wavefields and those wavefields are utilized to generate images related to the subsurface region.

### TECHNICAL FIELD

The present invention relates generally to subsurface exploration utilizing methods for data processing including the migration and inversion of seismic waves to determine subsurface characteristics of subsurface regions of interest.

### BACKGROUND OF THE INVENTION

Many prior art migration and inversion methods belong to the class of adjoint state problems where a forward and a backward-propagated wavefields are correlated to obtain an image. Examples of such methods include reverse-time migration, differential semblance velocity analysis and waveform inversion. These methods require that forward propagated wavefields be accessed in reverse order, in lockstep with the adjoint, backward-propagated wavefields at each time step.

This requirement of simultaneous availability of both the forward and backward-propagated wavefields at each time step poses significant computational challenges for large datasets. This challenge is typically associated with the forward-propagating wavefield where this wavefield needs to be made available to be accessed in reverse order. By reciprocity, the problem holds equally valid if the backward-propagating wavefield is accessed in reverse order to correlate with the forward-propagating wavefield. Several prior art methodologies were developed to address this issue and were summarized in Dussaud et al. (2008). The first strategy is associated with repeated forward propagation of the wavefield to the n-th timestep. Although this strategy is theoretically and computationally straightforward, its O(N²) or complexity in the order of N² computational cost is prohibitive for large datasets. The second set of strategies aims at minimizing the recomputation ratio by optimal wavefield storage strategies and interpolation. These strategies are mostly O(N) at the expense of storage of the wavefields for many timesteps. The third strategy is based on backward propagating the already forward-propagated source wavefield.

Each strategy is a different realization of the tradeoff between the (re)computation and the storage of the wavefields. As used in this broader context, storage is the cost to access the data in the memory hierarchy, including RAM, local hard drives and network-attached storage. This tradeoff is a function of both hardware and algorithmic considerations.

There exists a need to process wavefields and to generate images of a subsurface region of interest in a more efficient computational manner

### SUMMARY OF THE INVENTION

One embodiment of the present invention includes a computer-implemented method of generating images related to a subsurface region. The computer-implemented method includes obtaining seismic data and an earth model related to the subsurface region, wherein both the seismic data and the earth model are stored on electronic media. The method also includes utilizing at least one processor, configured to communicate with the electronic media and arranged to execute machine executable instructions stored in a processor accessible memory for performing steps comprising: establishing boundary conditions utilizing seismic data and initial conditions which include excitation from source locations in the earth model; propagating forward source wavefields through the earth model to a maximum time; saving source wavefields at a plurality of checkpoints sparsely in time and saving corresponding boundary values of the source wavefields at each time step (this step in contrast to the conventional I/O-bound approach which saves the source wavefield volumes at almost every time step); propagating backward the source wavefields through the earth model from the maximum time utilizing the plurality of checkpoints when available and the saved boundary values at each time step, and concurrently propagating backward receiver wavefields or seismic data through the earth model from the maximum time; and applying imaging conditions at selected time steps to both the backward propagated source wavefields and receiver wavefields, wherein the backward propagated source wavefields and receiver wavefields are utilized to generate images related to the subsurface region.

One benefit of the present invention is that it allows for efficient and accurate reconstruction of the source wavefields for solving adjoint state problems with minimal storage of partial wavefields; whereas a conventional I/O-bound approach relies on saving 3D wavefields at almost every time step. . The compute-bound approach in the present invention largely removes the expensive storage access time, a limiting factor for the computational performance of solving adjacent state problems. As a result, the present invention using computationally-based algorithms can scale much better than I/O-bound algorithms with both the employed hardware and different sizes of input datasets.

The present invention utilizes both snapshots or checkpoints and boundary conditions or values to reconstruct source wavefields for imaging with seismic data reversely extrapolated from receivers. The combined use of both sparsely saved checkpoints in the reverse propagation and boundary values leads to improved accuracy in wavefield reconstruction for RTM imaging. One embodiment of the present invention includes sparsely saving snapshots or checkpoints at every 200 time steps, which is an interval typical of 0.8 seconds. Other embodiments of the present invention include sparsely saving snapshots or checkpoints and boundary conditions between 50 to 400 time steps.

Several embodiments of the present invention utilize the computer-implemented method for reverse time migration, waveform inversion, or other applications requiring reverse order access of data components in order to operate with other data components.

One embodiment of the present invention includes the earth model which is extended with a slow-velocity cortex or a special boundary condition of other properties to accommodate source wavefields that propagated outside of the original boundary. The advantage of using such a cortex or a similarly special boundary condition is to retain the source wavefields in the computation grid for a full reconstruction from its maximum time state without involving disk storage at all.

One embodiment of the present invention propagates the wavefields utilizing a numerical solver. Embodiments of the present invention utilize a numerical solver which includes reverse time migration, Gaussian beam migration, Kirchhoff migration or waveform inversion. Still yet other embodiments of the present invention utilize a numerical solver which includes a wave-equation based migration.

Certain embodiments of the present invention may include the wavefield propagation being performed in the time, or frequency, or wavelet domain.

It should also be appreciated by one skilled in the art that the present invention is intended to be used with a system which includes, in general, an electronic configuration including at least one processor, at least one memory device for storing program code or other data, a video monitor or other display device (i.e., a liquid crystal display) and at least one input device. The processor is preferably at least one microprocessor or microcontroller-based platform which is capable of displaying images and processing complex mathematical algorithms. The memory device can include random access memory (RAM) for storing event or other data generated or used during a particular process associated with the present invention. The memory device can also include read only memory (ROM) for storing the program code for the controls and processes of the present invention.

One example of system which incorporates an embodiment of the present invention is a system configured to generate images related to a subsurface region of interest. The system includes a data storage device having seismic data and an earth model related to the subsurface region of interest. The system also includes at least one processor, configured and arranged to execute machine executable instructions stored in a processor accessible memory for performing a method. The method includes establishing boundary conditions utilizing the seismic data and initial conditions which include excitation from source locations in the earth model, and propagating forward source wavefields through the earth model to a maximum time. The method also includes utilizing the data storage device to save source wavefields at a plurality of checkpoints sparsely in time and saving corresponding boundary values of the source wavefields at each time step. The method further includes propagating backward the source wavefields through the earth model from the maximum time utilizing the plurality of checkpoints when available and the saved boundary values at each time step, and concurrently propagating backward receiver wavefields or seismic data through the earth model from the maximum time. The method includes applying imaging conditions at selected time steps to both the backward propagated source wavefields and receiver wavefields, wherein the backward propagated source wavefields and receiver wavefields are utilized to generate images related to the subsurface region on a display device.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural references unless the context clearly dictates otherwise.

### BRIEF DESCRIPTION OF THE DRAWINGS

These and other objects, features and advantages of the present invention will become better understood with regard to the following description, pending claims and accompanying drawings where:

FIG. 1 illustrates one embodiment of the present invention which includes a computer-implemented method of generating images related to a subsurface region.

FIG. 2 illustrates wavefield propagation for adjoint state problems such as RTM.

FIG. 3 illustrates the forward propagation of the wavefield in a finite medium at time T.

FIG. 4 illustrates the backward propagation of the wavefield in a finite medium at time T.

FIG. 5 illustrates the backward propagation of the wavefield in a finite medium at time t>T.

FIG. 6 illustrates a schematic diagram of reverse-time migration of one embodiment of the present invention.

FIG. 7 illustrates one embodiment of the present invention for reconstructing wavefields of previous time states from checkpoints in solving adjoint state problems, where p and q are two consecutive time states of wavefields

FIG. 8 illustrates one embodiment of the present invention for solving adjoint state problems.

FIGS. 9A to 9D illustrate the forward propagation of a source wavefield in a synthetic model for one embodiment of the present invention.

FIGS. 10A to 10D illustrate the reconstruction of an earlier wavefield after backward propagation using only boundary values for one embodiment of the present invention.

FIGS. 11A to 11D illustrate the results of where both the boundary values and sparse checkpoints (stored at every 250-th timestep) were utilized for one embodiment of the present invention.

FIGS. 12A to 12C illustrate the results for one embodiment of the present invention where only sparse checkpoints were utilized.

FIGS. 13A to 13D illustrate one embodiment of the present invention which includes I/O-free wavefield reconstruction using an extended cortex in forward modeling.

FIG. 14 illustrates one example of a system for implementing embodiments of the present invention.

### DETAILED DESCRIPTION OF THE INVENTION

Adjoint state problems, such as reverse-time migration, pose serious computational problems for large datasets and manifest themselves in the classical tradeoff between computation and storage. Algorithms realizing a particular tradeoff will have their computational performance limited by the particular tradeoff. For example, storage may be a limiting factor in many algorithms and hardware storage access rate may become the de facto computational rate for a given application. Other algorithms may be designed to balance the computation versus storage tradeoff in such a way that the computational and storage capacities of the system are optimally stressed. For best performance, algorithms should be adaptively designed to optimally use the computational and memory structure of a given new hardware, such as graphics processing units (GPU) or field-programmable gate arrays (FPGA).

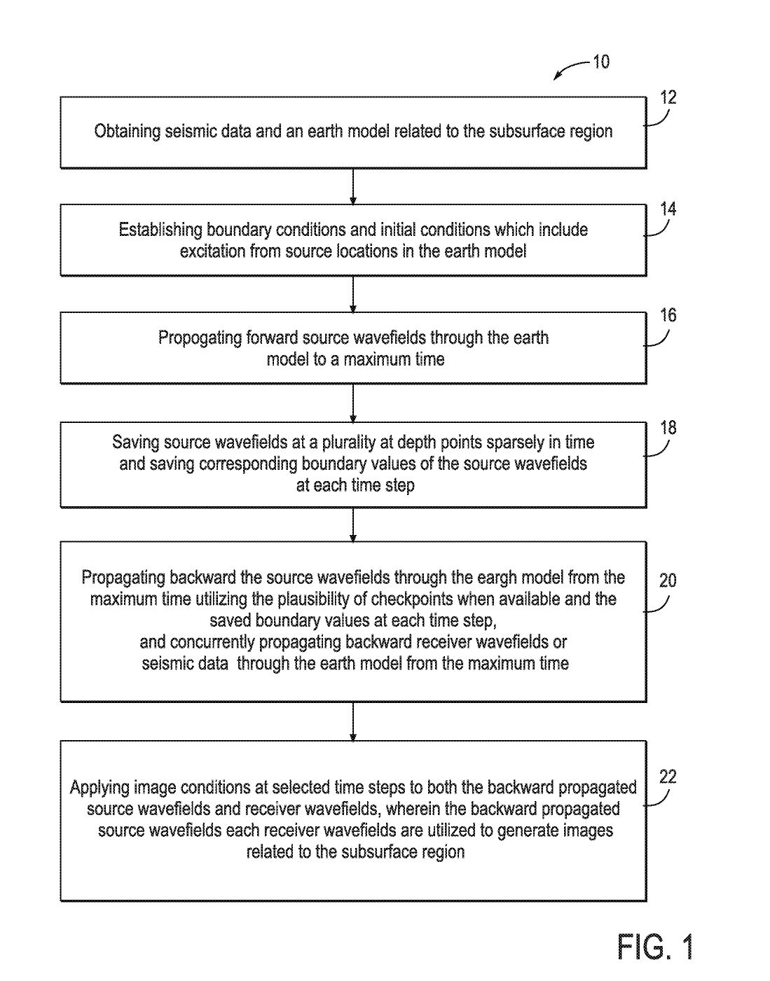

FIG. 1 illustrates one embodiment of the present invention which includes a computer-implemented method of generating images related to a subsurface region 10. The method includes obtaining seismic data and an earth model related to the subsurface region 12, and establishing boundary conditions and initial conditions which include excitation from source locations 14. The method further includes propagating forward source wavefields through the earth model to a maximum time 16, and saving source wavefields at a plurality of checkpoints sparsely in time and saving corresponding boundary values of the source wavefields at each time step 18. The method also includes propagating backward the source wavefields through the earth model from the maximum time utilizing the plurality of checkpoints when available and the saved boundary values at each time step, and concurrently propagating backward receiver wavefields or seismic data through the earth model from the maximum time 20. The method includes applying imaging conditions at selected time steps to both the backward propagated source wavefields and receiver wavefields, wherein the backward propagated source wavefields and receiver wavefields are utilized to generate images related to the subsurface region 22.

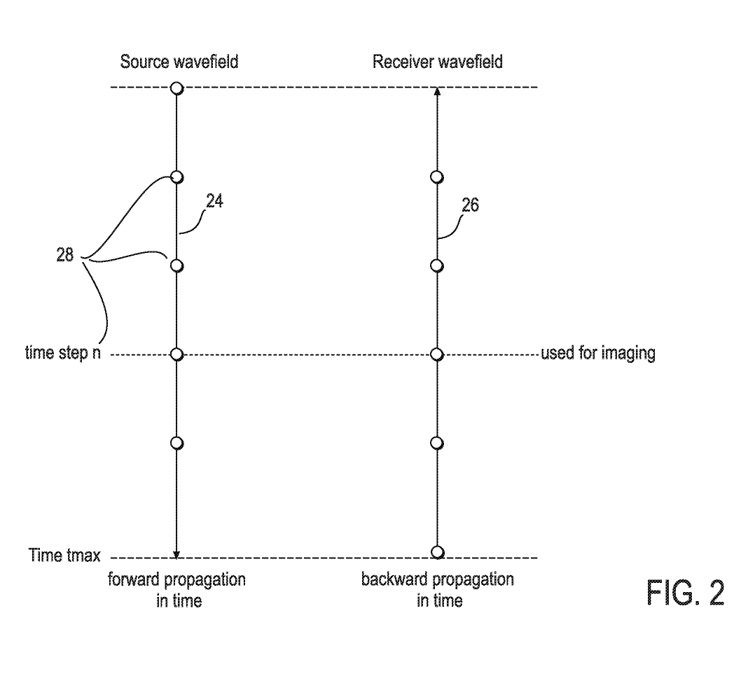

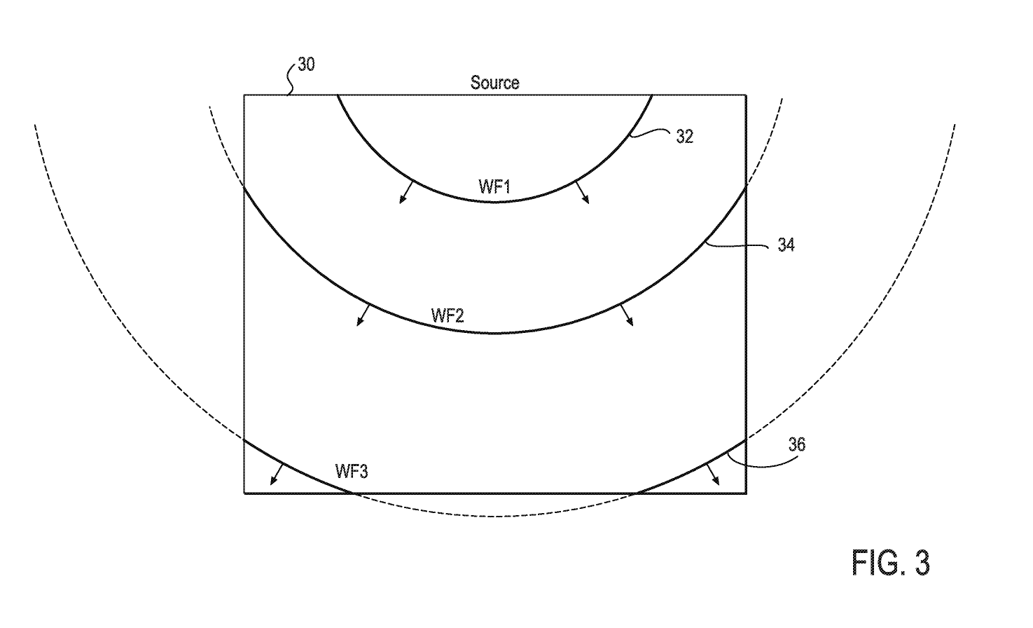

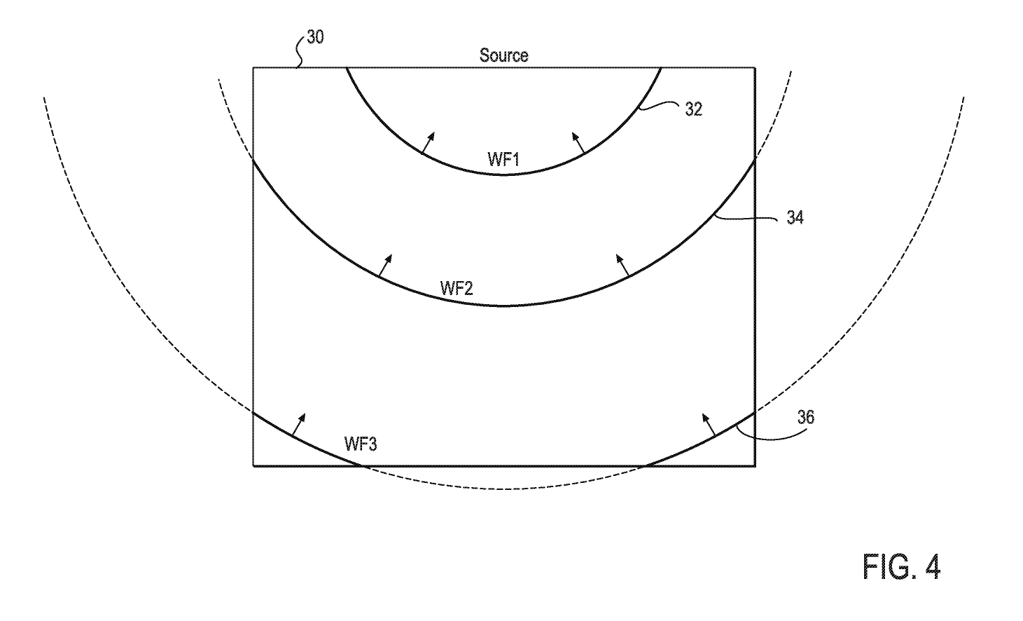

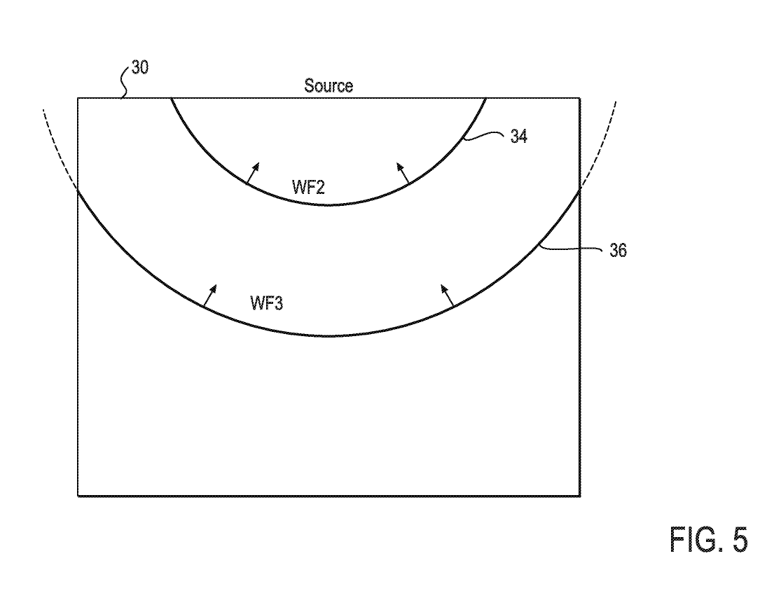

FIG. 2 illustrates wavefield propagation for adjoint state problems such as RTM. The source wavefield 24 is propagated forward and the receiver wavefield 26 is propagated backward in time. At any timestep 28, for example n, both the forward propagated source wavefield 24 and the backward propagated wavefield 26 need to be available simultaneously for imaging. FIG. 3 illustrates the forward propagation of the wavefield in a finite medium 30 at time T. Three wavefronts, denoted by WF1 32, WF2 34, and WF3 36, are being propagated in FIG. 3, and upon reaching the boundary of the medium 30, the wavefield is suppressed to avoid boundary reflections. FIG. 4 illustrates the backward propagation of the wavefield with wavefronts WF1 32, WF2 34 and WF3 36 at time T, and similarly at time t<T in FIG. 5. At time t, wavefields that have propagated outside of the medium boundaries at time step T need to be accessed. This requirement leads to the need of preserving wavefields that are leaving the computational domain during forward propagation to enable a full reconstruction in backward propagation.

There are three ways to store the wavefields that reach the boundaries of the computational domain: (a) storing wavefields (typically in 3D) at selected time steps, also called checkpointing; (b) storing the boundary values; and (c) enlarging the computational domain beyond the normally useful size with a cortex for buffering purposes. Storing 3D wavefields corresponds to saving the initial conditions for subsequent backward propagation. Due to the size and access rate of storing and retrieving large 3D wavefields, the snapshots (checkpoints) can be saved only after many (hundreds of) timesteps before it becomes the limiting factor of computational performance. Storing boundary values corresponds to saving the boundary conditions during forward propagation to reconstruct the out-of-domain wavefields during backward propagation. The computational cost associated with storing and retrieving these boundary values (6 2-D wavefields) is typically not a computational bottleneck. Enlarging the computational domain corresponds to providing an extra cortex to preserve complete wavefields for successive reconstruction without involving intermediate checkpointing. To ensure that these wavefields are kept bounded, low velocities or other properties may be used in the cortex area to retain wave propagation in the cortex. In real applications, these strategies can be mixed for best performance.

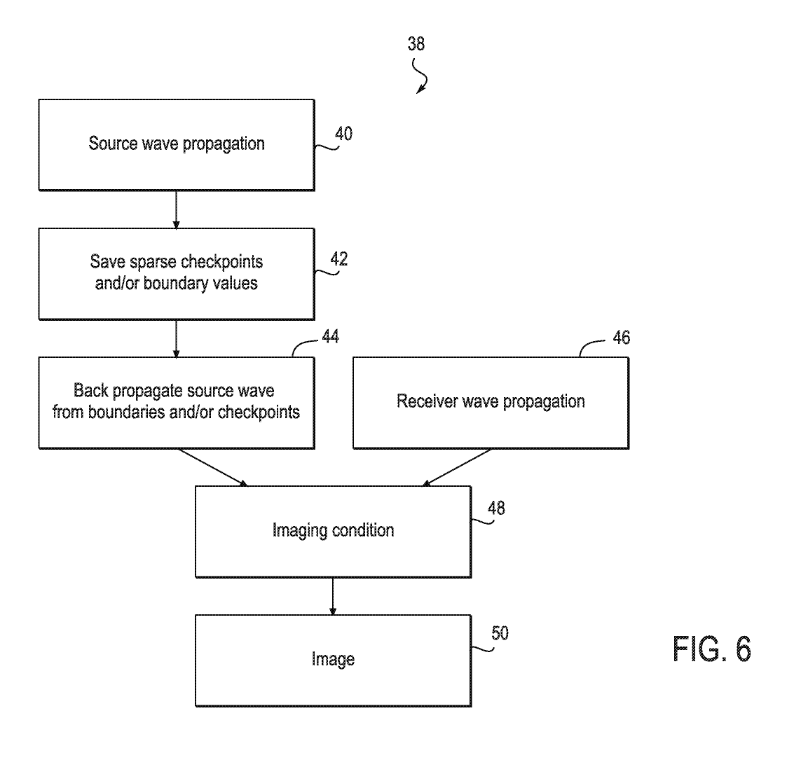

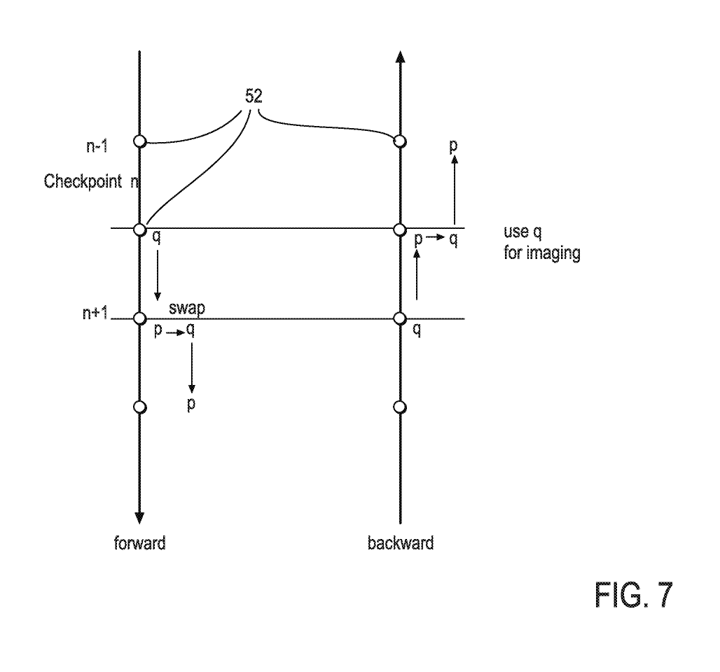

FIG. 6 illustrates a schematic diagram of reverse-time migration 38 of one embodiment of the present invention. The first step is the forward propagation of the source wavefield 40 and its updated wavefield values are saved as either sparse 3D checkpoints and/or boundary values at every time step in the second step 42. Once the source wavefield is fully propagated to the maximum time value, the source wavefield is backward propagated by using the saved checkpoints and boundary values in the third step 44. FIG. 7 illustrates how checkpoints n 52 are used as initial conditions to back propagate wavefields from current time to previous time steps, where p and q are two consecutive time states of wavefields used in either forward or backward propagation. The next step illustrated in FIG. 6 is the backward propagation of the receiver wavefield 46 which is carried out simultaneously with the back propagation of the source wavefield 44 and both wavefields are available concurrently to perform the imaging condition 48. The output from applying the imaging condition is saved in a cumulative image volume 50. Steps 44 through 50 are repeated for every time step until the minimum time is reached.

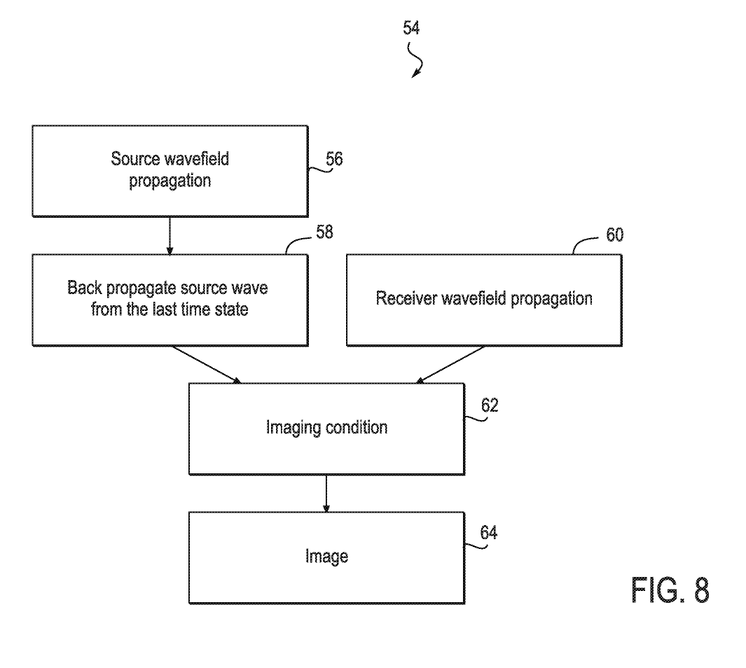

FIG. 8 illustrates another embodiment of the present invention 54 using the above-described third strategy (i.e. enlarging the computational domain beyond the normally useful size with a cortex for buffering or wavefield retaining purposes) for solving adjoint state problems, where no wavefields are stored and the forward-propagated source wavefield is backward propagated along with the receiver wavefield concurrently. This can be achieved, for example by extending the computational domain with an extra slow-velocity cortex or of other properties, as described in the present invention. In the workflow illustrated in FIG. 8, the source wavefield is propagated forward 56 and subsequently the source wavefield is back propagated from its final state at the maximum time 58. Concurrently with the back propagation of the source wavefield, the receiver wavefield is also propagated backwards 60. Both wavefields are then available to perform the imaging condition 62, which is applied to generate an image of the subsurface region of interest 64.

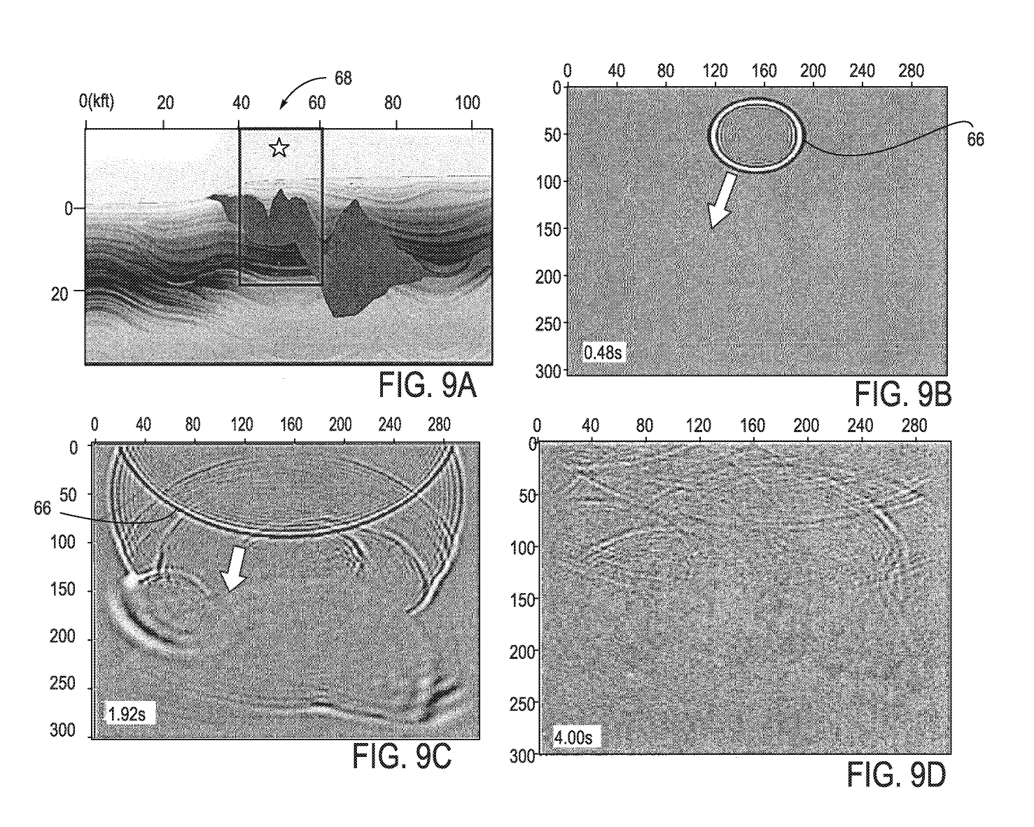

FIGS. 9A to 9D illustrate the forward propagation of a source wavefield 66 in a synthetic model for one embodiment of the present invention. FIG. 9A depicts the subsurface earth model 68 utilized in this embodiment of the present invention. FIGS. 9B to 9D illustrate the time snapshots at different times where the source wavefield 66 is propagated forward.

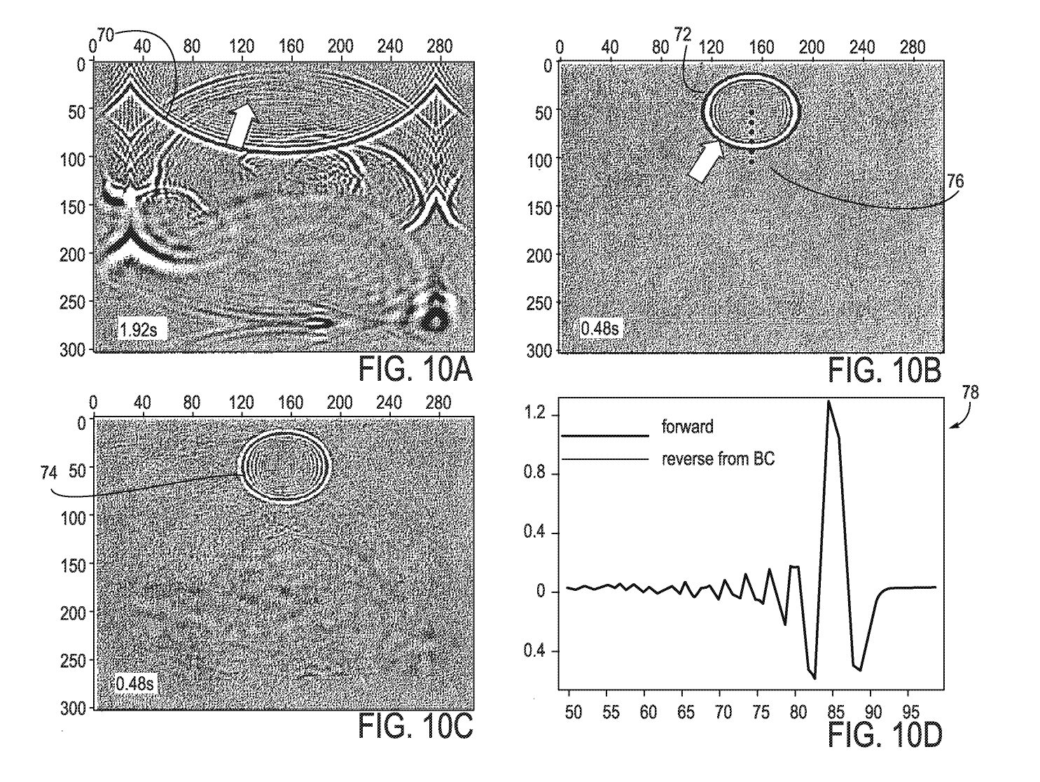

FIGS. 10A to 10D illustrates the reconstruction of an earlier wavefield 70 after backward propagation using only boundary values for one embodiment of the present invention. FIG. 10A illustrates the initial wavefield 70 and FIG. 10B illustrates the reconstructed wavefield 72. FIG. 10C is the difference 74 (magnified by 10 times) between the reconstructed wavefield 72 and the forward propagated wavefield 66 illustrated in FIG. 9B. FIG. 10D shows a detailed plot of a seismic trace 78 profiled from locations denoted by the dash line 76 in FIG. 10B.

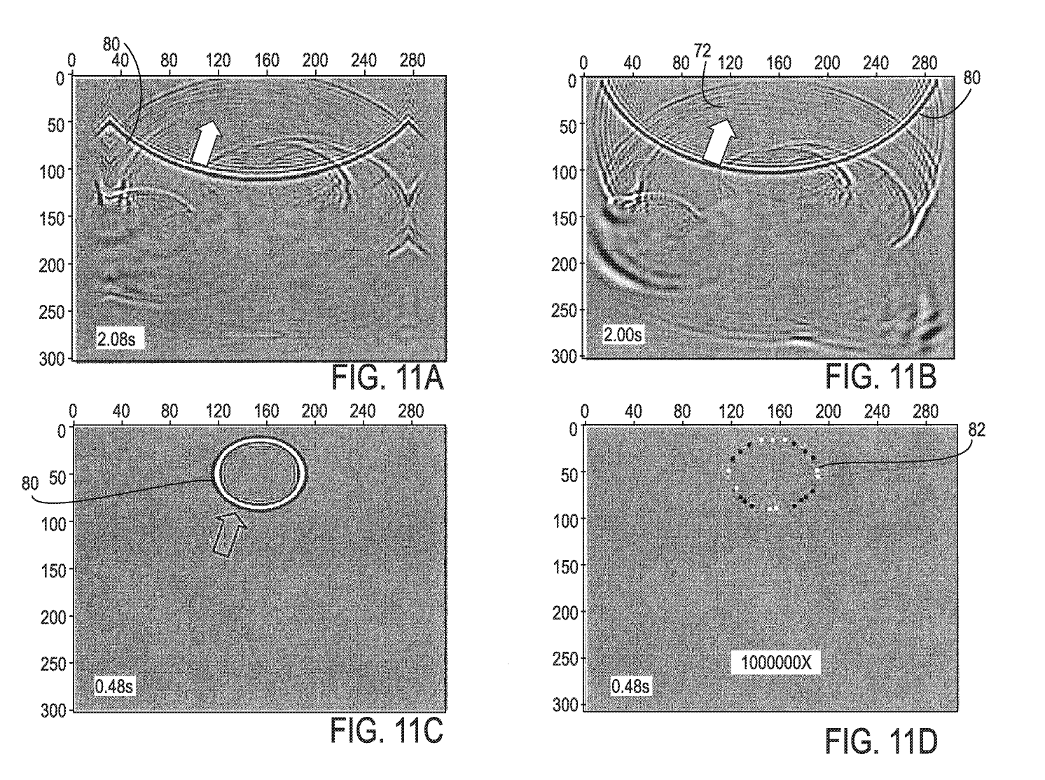

FIGS. 11A to 11D illustrate the results of where both the boundary values and sparse checkpoints (stored at every 250-th timestep) were utilized for one embodiment of the present invention. FIG. 11D illustrates the accuracy of reconstruction 82 by comparing the differences between the reconstructed wavefield 80 (FIG. 11A to C) and the saved wavefield 66 (FIG. 9B).

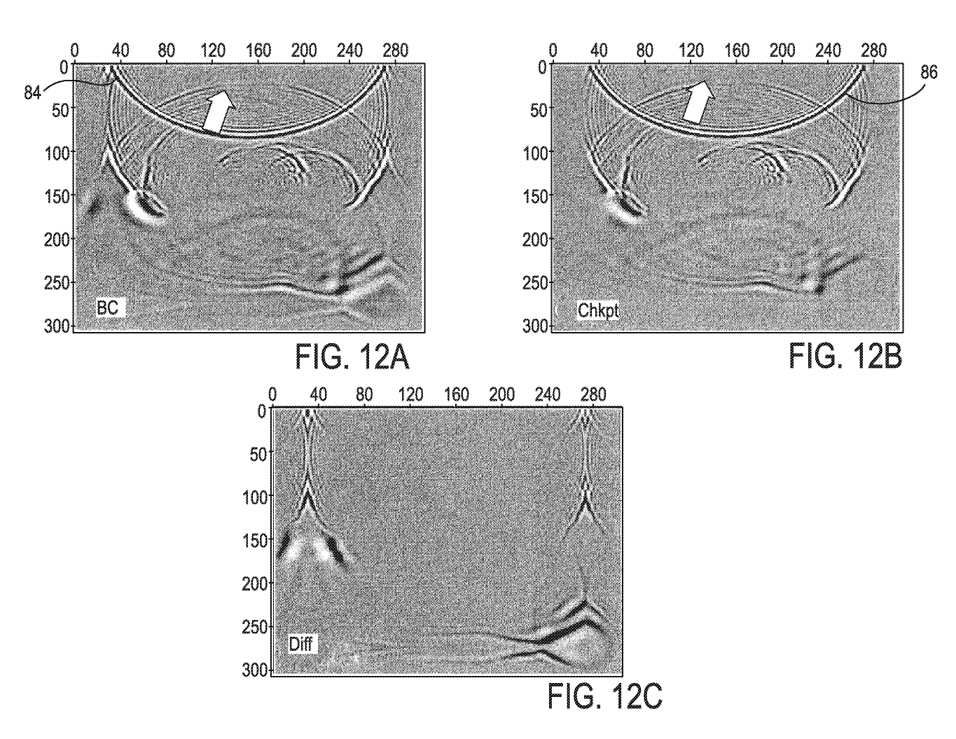

Additionally, FIGS. 12A to 12C illustrate the case where only sparse checkpoints were utilized. FIG. 12A illustrates the wavefield reconstructed by injecting boundary values 84 and FIG. 12B is the wavefield 86 which was reconstructed using only sparse checkpoints. FIG. 12C illustrates the differences between the reconstructed wavefield by boundary value injections 84 and by sparse checkpoints 86.

All the results illustrated in FIGS. 9A to 9D, 10A to 10D, 11A to 11D and 12A to 12C correspond to particular realizations of the embodiment illustrated in FIG. 6. The results illustrated in those figures indicate that using both the boundary values and sparse checkpoints jointly achieves the error-free reconstruction of an earlier wavefield. The boundary value only and checkpoint only experiments also yield acceptable reconstruction at large portions of the computational model.

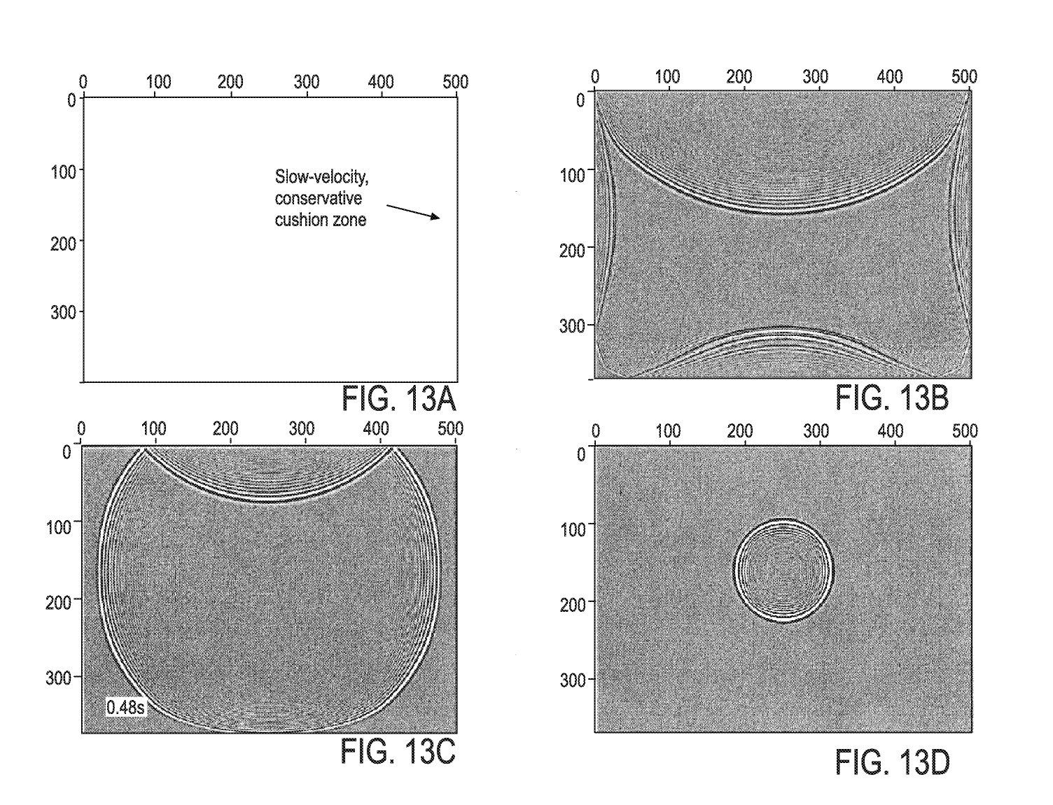

FIGS. 13A to 13D illustrate I/O-free wavefield reconstruction using an extended cortex in forward modeling. FIG. 13A illustrates specifying a slow-velocity cushion zone in the extended cortex, and FIGS. 13B to 13D illustrate the reconstructed wavefields by back propagating the last time state from forward modeling.

The above-described embodiments of the present invention provide several advantages relative to conventional strategies for solving adjoint state problems. The joint usage of boundary values and sparse checkpoints enable accurate reconstruction of wavefields and reduces storage costs in such a way that the overall performance of algorithms is strictly compute-bound. The boundary values only and checkpoint only implementations are even more compute-bound, at the expense of some reduction in accuracy in wavefield reconstruction. The I/O-free implementation using only the last time state also provides accurate reconstruction at the expense of additional wavefield computation in the extended cortex area.

The significance of compute-bound algorithms is further enhanced when the tradeoff between computational speed and data access ratio at the slower hierarchical levels of storage is further biased toward computational speed. In such cases avoiding computational performance limitations due to storage access rate is even more important. This underscores the significance of compute-bound solutions to adjoint state problems, since in the future, hardware architectures with even faster computational speeds compared to data storage access are expected. For example, a FPGA is capable of maintaining computational speed at a much higher rate than traditional CPUs for certain applications. To fully utilize this capacity of FPGAs or GPUs, storage access-limited schemes need to be avoided.

One skilled in the art will appreciate that embodiments of the present invention can be implemented on either co-processor accelerated architectures, such as FPGAs, GPUs, cells or on general-purpose computers. The present invention also includes apparatuses, general-purpose computers and/or co-processors programmed with instructions to perform a method for the present invention, as well as computer-readable media encoding instructions to perform a method of the present invention.

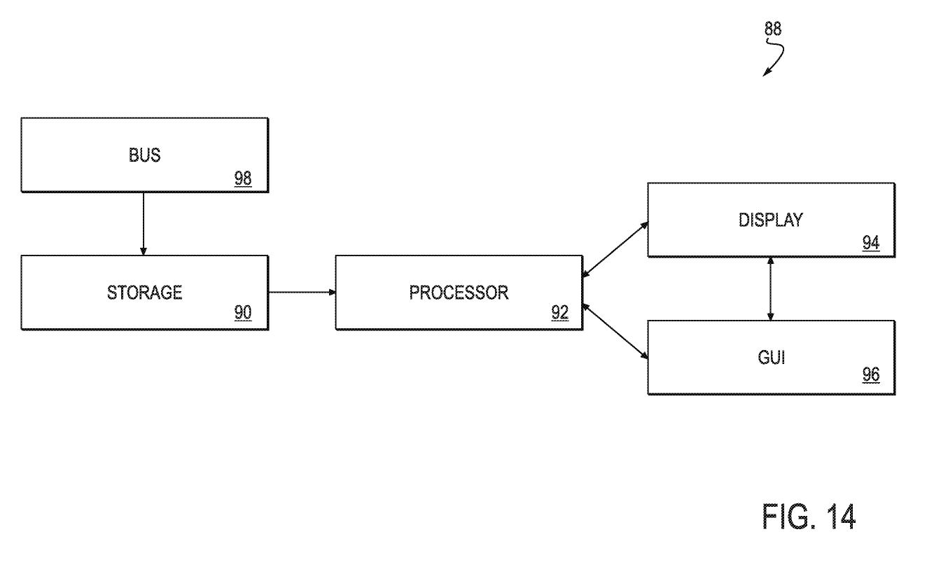

An example of a system for performing the present invention is schematically illustrated in FIG. 14. A system 88 includes a data storage device or memory 90 for storing electronic media. The stored data may be made available to at least one processor 92, such as a programmable general purpose computer and/or co-processors configured to communicate with the electronic storage media and execute computer program modules stored in the electronic storage media. The processor 92 may include interface components such as a display 94 and a graphical user interface (GUI) 96. The GUI 96 may be used both to display data and processed data products and to allow the user to select among options for implementing aspects of the method. Data may be transferred to the system 88 via a bus 98 either directly from a data acquisition device, a network, or from an intermediate storage or processing facility (not shown).

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A computer-implemented method of generating images related to a subsurface region; the method comprising:
obtaining seismic data and an earth model related to the subsurface region, wherein both the seismic data and the earth model are stored on electronic media;
utilizing at least one processor, configured to communicate with the electronic media and arranged to execute machine executable instructions stored in a processor accessible memory for performing steps comprising:
establishing boundary conditions utilizing the seismic data and initial conditions which include excitation from source locations in the earth model;
propagating forward source wavefields through the earth model to a maximum time;
saving source wavefields at a plurality of checkpoints sparsely in time and saving corresponding boundary values of the source wavefields at each time step;
propagating backward the source wavefields through the earth model from the maximum time, utilizing the plurality of checkpoints when available and the saved boundary values at each time step, and concurrently propagating backward receiver wavefields or seismic data through the earth model from the maximum time; and
applying imaging conditions at selected time steps to both the backward propagated source wavefields and receiver wavefields from seismic data, wherein the backward propagated source wavefields and receiver wavefields are utilized to generate images related to the subsurface region.

2. The method of claim 1 wherein the computer-implemented method is utilized for reverse time migration, waveform inversion, or an application requiring reverse order access of data components in order to operate with other data components.

3. The method of claim 1 wherein the earth model is extended with a slow-velocity cortex or a boundary condition of properties to accommodate source wavefields that propagated outside of the original boundary.

4. The method of claim 1 wherein the wavefields are propagated utilizing a numerical solver.

5. The method of claim 4 wherein the numerical solver includes comprises at least one reverse time migration, Gaussian beam migration, Kirchhoff migration or waveform inversion.

6. The method of claim 4 wherein the numerical solver includes a wave-equation based migration.

7. The method of claim 1 wherein the wavefield propagation is performed in time, frequency or wavelet domains.

8. A system configured to generate images related to a subsurface region of interest, the system comprising:
at least one data storage device having seismic data and an earth model related to the subsurface region of interest;
at least one processor, configured and arranged to execute machine executable instructions stored in a processor accessible memory for performing a method comprising:
establishing boundary conditions utilizing the seismic data and initial conditions which include excitation from source locations in the earth model;
propagating forward source wavefields through the earth model to a maximum time;
utilizing the data storage device to save source wavefields at a plurality of checkpoints sparsely in time and saving corresponding boundary values of the source wavefields at each time step;
propagating backward the source wavefields through the earth model from the maximum time utilizing the plurality of checkpoints when available and the saved boundary values at each time step, and concurrently propagating backward receiver wavefields or seismic data through the earth model from the maximum time; and
applying imaging conditions at selected time steps to both the backward propagated source wavefields and receiver wavefields, wherein the backward propagated source wavefields and receiver wavefields are utilized to generate images related to the subsurface region on a display device.

9. The system of claim 8 wherein the method is utilized for reverse time migration, waveform inversion, or an application requiring reverse order access of data components in order to operate with other data components.

10. The system of claim 8 wherein the earth model is extended with a slow-velocity cortex or a boundary condition of properties to accommodate source wavefields that propagated outside of the original boundary.

11. The system of claim 8 wherein the wavefields are propagated utilizing a numerical solver.

12. The system of claim 11 wherein the numerical solver comprises at least one of reverse time migration, Gaussian beam migration, Kirchhoff migration or waveform inversion.

13. The system of claim 11 wherein the numerical solver includes a wave-equation based migration.

14. The system of claim 8 wherein the wavefield propagation is performed in time, frequency or wavelet domains.
